(19) United States
(12) Patent Application Publication
(10) Pub. No.: US 2023/0194370 A1
(43) Pub. Date: Jun. 22, 2023

(54) Wearable Garments Having Force And Inertial Sensing Capabilities

(71) Applicant: Shuhari Group, LLC, Nevis (KN)

(72) Inventors: Kodiak Brush, Carlsbad, CA (US); Chad Skelton, Carlsbad, CA (US); Travis Downing, Carlsbad, CA (US)

(73) Assignee: Shuhari Group, LLC, Nevis, West Indies (KN)

(21) Appl. No.: 18/086,409

(22) Filed: Dec. 21, 2022

Related U.S. Application Data
(60) Provisional application No. 63/292,334, filed on Dec. 21, 2021.

(51) Int. Cl. G01L 5/00; G01L 5/161; G01P 15/18; A63B 69/32; A63B 24/00

(52) U.S. Cl. CPC G01L 5/0052; A63B 24/0062; A63B 69/32; G01L 5/161; G01P 15/18; A63B 69/215

(57) ABSTRACT

Methods and systems for force and inertial sensing in a garment. The system may include one or more wearable garments. The one or more garments may include one or more layers and an outer surface. Additionally, a force sensing array including a plurality of force sensing resistors, an inertial measurement unit, and a transmitter unit may be disposed within the one or more garments. A processor may comprise one or more receivers and may connect to the force sensing array, inertial measurement unit, or transmitter unit.

### BACKGROUND

Martial arts are dangerous combat sports often requiring participants to exchange sequences of blows of varying impact with one another. Under certain conditions, such blows can result in bodily injury. For example, these blows may refer, among other things, to punching, kicking, striking, jabbing, grappling, grabbing, chopping, and throwing. Participants of the sport often employ garments for protection.

Garments worn by martial artists are conventionally designed to minimize risk of injury. However, these conventional garments are not currently adapted to perform functionalities beyond mere protection. Thus, adapting these and other garments beyond mere protection is unappreciated by the art.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the examples of the present invention and should not be used to limit or define the invention.

FIG. 1 is a mannequin to illustrate regions of a body;

FIG. 2A illustrates a stand-alone wrist unit;

FIG. 2B illustrates a top profile of a wrist unit being worn palm facing upwards;

FIG. 2C illustrates a top profile of a wrist unit being worn palm facing downwards;

FIG. 2D illustrates a top profile of a wrist unit being worn palm facing downwards and with a clenched fist;

FIG. 2E illustrate a wrist unit;

FIG. 3A illustrates a front profile of an ankle unit with feet facing forwards;

FIG. 3B illustrates mirrored side profiles of an ankle unit;

FIG. 4 illustrates a training sleeve;

FIG. 5 illustrates a head unit;

FIG. 6 illustrates a leg unit;

FIG. 7A illustrates a chest unit;

FIG. 7B illustrates a layered view of a chest unit;

FIG. 7C illustrates hardware embedded in a chest unit;

FIG. 8A illustrates a layered view of a glove;

FIG. 8B illustrates a back side of a glove secured by a fastener;

FIG. 8C illustrates a back side of a glove with a device embedded therein;

FIG. 8D illustrates a front side of a glove;

FIG. 9 is an exemplary schematic representing a system in accordance with certain examples; and

FIG. 10 is a work flow for an example system.

### DETAILED DESCRIPTION

The present disclosure relates to methods and systems for dynamically tracking activity. More particularly, the present disclosure relates to systems including wearable garments having motion tracking and force sensing capabilities.

Advantages of the present disclosure include, in some examples, an ability to reliably gauge performance. In certain examples, speed, power, and accuracy of impacts are measured, stored, and displayed.

In other examples, an impact force may be redistributed to a broad surface area. In other examples, an impact force may be at least partially redistributed to a plurality of sensors. For example, in certain examples, a single impact force may be redistributed across an array of sensors. In some examples, an amount of force applied to an area may be determined.

Further, wearable garments disclosed herein may, in certain examples, be worn by a trainee, trainer, or combatant during physical activity, such as during training, sparring, or exercising. In other examples, the wearable garments may be worn by an inanimate object, such as a mannequin. For example, a trainee may strike an inanimate object upon which wearable garments are disposed. As such, the wearable garments may protect an inanimate object from becoming damaged.

The wearable garments described herein may generally comprise one or more layers, a surface, and one or more sensors. These wearable garments may also comprise, among other things, one or more telemetry devices, one or more microchips, and one or more input ports. Sensors may be selected from any conventionally known sensors or may be selected from any of force sensing resistors (FSRs), inertial measurement units (IMUs), gyroscopes, and accelerometers.

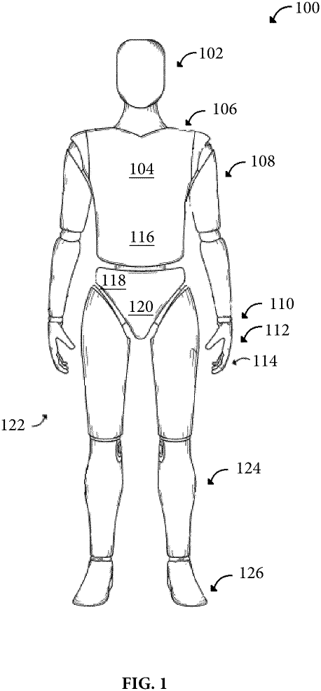

FIG. 1 is a mannequin to illustrate regions of a body whereupon various garments may be worn according to certain examples of the present disclosure. As illustrated, a mannequin 100 may have humanoid features. It should be understood that, while mannequin 100 is shown as an inanimate object having humanoid features, the systems and devices disclosed herein may be applied to activities involving inanimate objects lacking humanoid features, or alternatively, to activities involving animate organisms (e.g., people) without departing from the spirit of the disclosure. It is contemplated that certain “wearable” devices, while being shown and described as being “worn” on certain parts of a humanoid body, may also be applied to, say, punching bags, without departing from the spirit of the disclosure. Therefore, as used herein, the term “wearable garment” may refer to, in addition to any vernacular meaning associated with the term, any fabric, material, or any other device disclosed herein which may be donned by an animate or inanimate object or person.

Referring again to FIG. 1, mannequin 100 may include a head 102, a torso 104, a trapezoid region 106, arms 108, a wrist 110, a hand 112, fingers 114, an abdominal region 116, hips 118, a groin region 120, legs 122, shins 124, and feet 126. While not explicitly referred to, additional humanoid body parts, shown or not shown by mannequin 100, may also be included. Wearable garments of the types disclosed herein, in addition to those not disclosed, may be conjoined with the devices and systems of the present disclosure, and worn on any body part. Suitable wearable garments may include, for example, head gear, helmets, a chest unit, leg units, ankle units, wrist units, arm units, shin units, feet units, gloves, abdominal units, derivatives thereof, any combinations thereof, and/or the like. The size and shape of the wearable garments may be adjustable, as needed, to maximize functionality of the devices and systems presently disclosed. Additionally, the wearable garments may comprise motion tracking, location tracking, inertia tracking, and force sensing capabilities, to be discussed later in detail. For example, the wearable garments may be attached to, embedded with, or otherwise include force sensing resistors (FSRs), gyroscopes, accelerometers, inertial measurement units (IMUs), power sources (i.e., batteries), telemetry devices, transmitters, receivers, wired and wireless signal means, electric generators, power converters, power management systems, and the like.

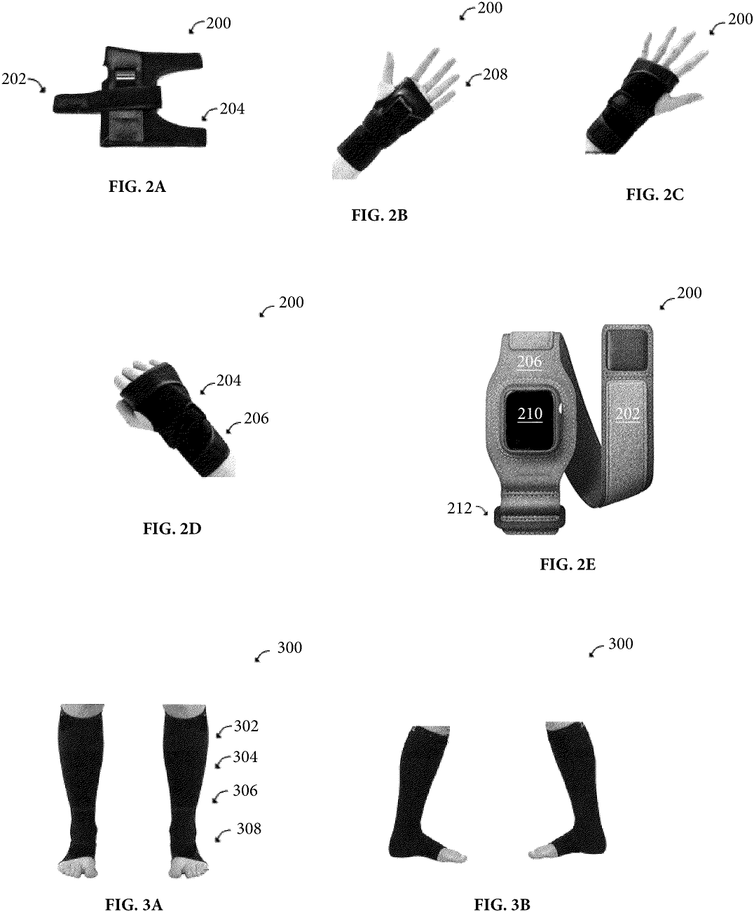

FIG. 2A illustrates a stand-alone wrist unit 200. Wrist unit 200 may be worn, for example, on wrist 110 (referring to FIG. 1), or on a region at least partially encompassing hand 112, and/or a region between arm 108 and wrist 110 (e.g., forearm). As shown, wrist unit may comprise an adjustable strap 202, one or more layers 204, and a surface 206. The adjustable strap 202 may be tightened or loosened. The wrist unit 200 may include Velcro, buckles, loops, fasteners, or any other technique or means of fashioning as is conventionally known. For example, the adjustable strap 202 may additionally, or alternatively, comprise an elastic band. While only a single layer 204 is shown, wrist unit 200 may include multiple layers, such as at different locations of the wrist unit 200. The layers 204 may comprise any suitable material, such as cotton, nylon, spandex, silk, linen, wool, polyester, rayon, synthetic materials, cellulosic fibers, leather, polymeric materials, woven materials, or any other suitable textile or combination thereof.

FIG. 2B illustrates wrist unit 200 from an inner (i.e., palm-facing-up) side of a wrist 110 (referring to FIG. 1). As shown, wrist unit 200 may be wrapped around a hand 112 (referring to FIG. 1), and an opening 208 may be included to allow fingers 114 (referring to FIG. 1) to protrude. Alternatively, the opening 208 may be omitted, and wrist unit 200 may instead comprise a glove. A support 209 may be included so that, when forces are applied to support 209, a rigid material may provide support so as not to contort or bend.

FIG. 2C illustrates wrist unit 200 from an outer (i.e., palm-facing-down) side of a wrist 110 (referring to FIG. 1). Padding (not shown) may be included in wrist unit 200, such as between two layers 204, or within a pocket affixed to either side of wrist unit 200. A surface 206 may be disposed on an outer side of wrist unit 200. As mentioned above, the wrist unit 200 may include motion tracking sensors, location tracking sensors, a power supply, an inertial measurement unit, telemetry devices, transmitters, force sensors, and/or any other electronic or other hardware described herein.

FIG. 2D illustrates a top profile of a wrist unit 200 being worn palm facing downwards. As shown, fingers 114 (referring to FIG. 1) may protrude out of opening 208 such that the wrist unit 200 is operable to allow clenching of a fist. In examples, a fist may be used in some examples to apply an impact force to other wearable garments.

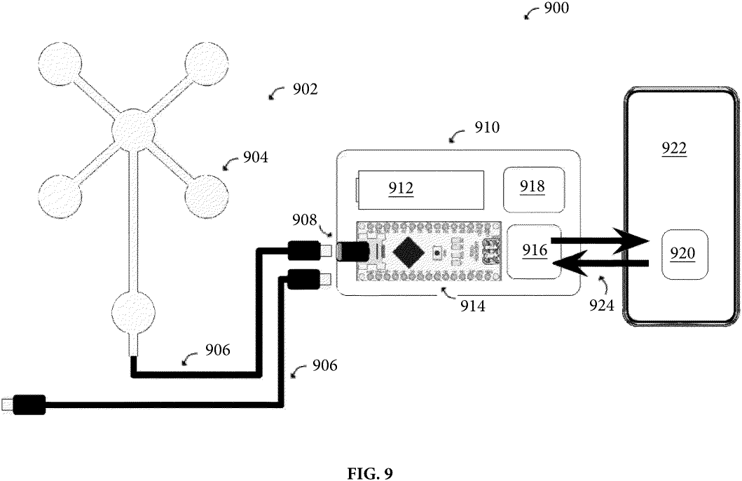

FIG. 2E illustrates a wrist unit 200. As shown, wrist unit 200 may include a display 210, an adjustable strap 202, and a fastener 212. The fastener 212 may be a latch, Velcro, string, buckle, or any suitable means of fastening wrist unit 200 to a wrist 110 (referring to FIG. 1). Display 210 may be coupled to processor 922 (referring to FIG. 9), or to any suitable device, such as via a connectivity (not shown). Connectivity may comprise any wired or wireless connectivity including, for example, Bluetooth, radio, infrared, microwave, Wi-Fi, mobile communication, broadcast, the like, or combinations thereof. One or more performance metrics 1108 or 1208 (referring to FIGS. 11 and 12) and/or performance-specific feedback 1212 may be rendered on display 210, such as on a GUI. Wrist unit 110 may include a transmitter unit (not shown) attached thereto or may alternatively have inertial, accelerometric, gyroscopic and/or other built-in motion detecting sensors embedded therein. Wrist unit 110 may comprise a wrist watch, and in some examples, may be equipped with wearable computing functionality, such as a “smart watch.” Any suitable wearable computing device may be used in combination with and, in certain examples, replacement for wrist unit 110.

FIG. 3A illustrates a front profile of an ankle unit with feet facing forwards. As illustrated, a pair of ankle units 300 may be disposed on legs 122 (referring to FIG. 1). Ankle units 300 may comprise a shin band 302 operable to retain tension around any region of legs 122, or alternatively, around shin 124. Shin band 302 may comprise any suitable elastic material allowing ankle unit 300 to align vertically and horizontally with a shin 124, such as any elastomer, or any stretchy material capable of undergoing rapid and reversible elastic deformation.

FIG. 3B illustrates mirrored side profiles of an ankle unit. Ankle unit 300 may comprise one or more layers and a surface. Padding (not shown) may be included in ankle unit 300, such as between two layers. Hardware, such as sensors, gyroscopes, accelerometers, transmitters, receivers, a power supply, FSRs, and combinations thereof, may be disposed in or throughout ankle unit 300.

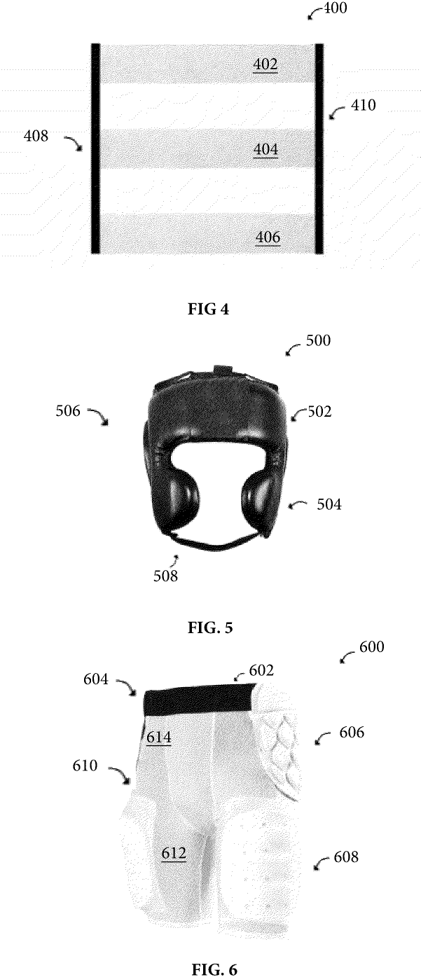

FIG. 4 is a training sleeve 400. Training sleeve 400 may be worn an any suitable part of mannequin 100, or on any part of an inanimate object. For example, training sleeve 400 may be worn on a wrist 110 (referring to FIG. 1), an arm 108, a leg 122, a shin 124, a forearm, and so forth. Training sleeve 400 may comprise a first band 402 attached to a second band 404 and/or a third band 406 by supports 408 and 410. Supports 408 and 410 may comprise elastic materials, such as the elastomeric materials previously described. Supports 702 and 704 may comprise an inner and outer surface, either of which, or both, may include an adhesive surface. Where used, an adhesive surface may allow training sleeve 400 to be adhered to or assembled on an inanimate surface, such as to the outside of an object (e.g., punching bag). Additionally, or alternatively, training sleeve 400 may be worn by a person. Supports 408 and 410 may allow for various spacing configurations, such as between a first band 402, a second band 404, and a third band 406. However, when not assembled, spacing may be consistent between first, second and third bands 402, 404, and 406.

First band 402 may be formed of an elastic material with an adhesive inner surface. First band 402 may comprise two separate strips, each connected between the first elastic support 408 and the second elastic support 410. The outer edges of first elastic support 408 and the second elastic support 410 may be selectively more adhesive than their respective inner surfaces to form a tighter coupling to first band 402 than the object they are assembled to. Thus, a cylindrical like shape for training sleeve 400 is formed and can act as a sleeve when assembled around an object. When training sleeve 400 is assembled around the outside of an object, first band 402 may form firmly around the outside of the object and remain static with minimal sliding. Second band 404 and third band 406 may be formed of the same elastic material with an adjustably adhesive inner surface. Additionally, any number of bands may be implemented within training sleeve 400. Thus, training sleeve 700 may be tightly formed around a wide-ranging shape and size of objects. Elastic supports 702 and 704, first band 706, second band 708, third band 710, and any additional bands may also comprise motion tracking sensors, location tracking sensors, and force sensors. Such sensors may be implemented as previously described in FIG. 2 with gyroscopes, accelerometers, transmitters, receivers, and FSRs disposed throughout any of Elastic supports 702 and 704, first band 706, second band 708, third band 710, and any additional bands. Training sleeve 700 may further comprise a power supply, as previously described. The power supply may be configured to provide power to sensors disposed around training sleeve 700.

FIG. 5 is a head unit 500. Head unit 500 may be worn, such as on head 102 (referring to FIG. 1). As illustrated, head unit 500 may comprise one or more layers 502, a surface 504, padding 506, and a chin strap 508. Any suitable conventional attachment mechanism may be used in place of or in addition to chin strap 508 or the chin strap 508 may be omitted altogether. Layers 502 may include a single layer, or may include several, and padding 506 may be disposed between layers 502 or embedded within a single layer 502. Head unit 500 may comprise a singular cohesive structure or, alternatively, may comprise a plurality of structures positioned to form a roughly spherical configuration to be disposed around, for example, head 102 (referring to FIG. 1). Padding 506 may serve a protective function, such as to absorb the impact of an applied force, such as a blow or strike to the head. In examples where multiple layers 502 are used, individual layers may comprise the same, or different materials. For example, a single dense, hard-core material may be used to form a shell, or a combination of a dense, hard-core material and a low-density, soft mesh may be used, such as with a soft inner layer 502 and a harder outer layer 502. For example, head unit 500 may comprise an absorbable padded outer shell, a hard-core shell, and/or a soft inner mesh. In some examples, head unit 500 may comprise one or more rigid or semi-rigid layers, such as two rigid or semi-rigid layers having standoffs disposed therebetween to dissipate the impact of a blow or strike to the head to a plurality of force sensing resistors, or more generally, to a large surface area than the contact area of the blow or strike.

Headgear 500 may comprise any number of sensors disposed throughout non limiting locations within the at least one layer. The sensors receivers disposed in headgear 500 may rely on different physical properties to provide measurements including but not limited to motion, location, and force. Motion tracking sensors may comprise accelerometers and gyroscopes operable to transmit motion measurements in real time to a processor in real time via a wireless communication link, to be discussed in detail later. Location tracking sensors may be implemented within headgear 500. The location tracking sensors may include transmitters and receivers operable to implement Global Positioning Systems (GPS), Wi-Fi Positioning Systems (WPS), Radio-frequency identification (RFID) positioning system, and the like. Location tracking sensors may further be operable to transmit location measurements in real time to processing unit 802 in real time via a wireless communication link 804. Force sensors may be any implementation of force-sensitive resistors (FSRs) operable to measure force measurements in real time and transmit to a processor in real time via a wireless communication link. FSRs may be implemented throughout headgear 500. Headgear 500 may further comprise a power supply including but not limited to electric batteries, electric generators, AC-DC/DC-AC/AC-AC/DC-DC converters, power management systems, and the like.

FIG. 6 is a leg unit 600. Leg unit 600 may be worn, for example, on any part of leg 122 (referring to FIG. 1), such as on shin 124, or on a region of leg 122 encompassing a portion of leg 122 (e.g., over a knee cap), or, in some examples, over a portion of a foot 126. As illustrated, leg unit 600 may comprise a belt 604, padding 606 and 608, mesh 610, a surface 614, and one or more layers 612. As with the previous wearable garments having one or more surfaces, any suitable amount of padding may be included with the layers 612, such as between two layers 612 or embedded within a single layer 612. Padding 406 may provide extra support for the one or more layers 612, and may be multi-layered, such as multi-layered with a padded surface. The layers may comprise any suitable material, such as a same material or a different material for each layer 612. For example, a layer 612 may comprise a mesh 610, such as a breathable mesh to permit air and moisture to diffuse through surface 614, or may alternatively, or additionally, comprise one or more rigid or semi-rigid layers, such as two rigid or semi-rigid plates having standoffs disposed therebetween. In breathable mesh examples, all, or any individual layer of the one or more layers may have perforations disposed therethrough, or alternatively, may include adhesive edges in locations around padding 606, padding 608, band 602, or belt 604. Belt 604 may comprise any suitable fastener, such as those previously described, may be substituted for an elastomeric band or stretchy material, or may be omitted altogether. The padding, while shown in FIG. 6 as occupying regions proximate to hip 118 (referring to FIG. 1) and an upper portion of leg 122 (referring to FIG. 1), may be disposed in any suitable location, such as in an area covering or proximate to groin 120 (referring to FIG. 1), or an area covering or proximate to, for example, a knee cap.

With continued reference to FIG. 6, in some examples, leg unit 600 may be disposed on or around legs 122. Leg unit 600 may comprise elastic band 602 with an optional belt 410 for different heights and shapes of combatant 100. Further, a mesh 610 may form the structure of leg unit 600 and may be of an elastic material allowing for flexibility to legs 112 (referring to FIG. 1). Leg guard 400 may also comprise motion tracking sensors, location tracking sensors, and force sensors. Such sensors may be implemented as previously described in FIG. 2 with gyroscopes, accelerometers, transmitters, receivers, and FSRs disposed throughout padding 606, padding 608, mesh 610, and elastic band 602. Leg unit 600 may further comprise a power supply, as previously described. For example, a power supply may be needed to provide power to sensors and/or hardware disposed in or around leg unit 600.

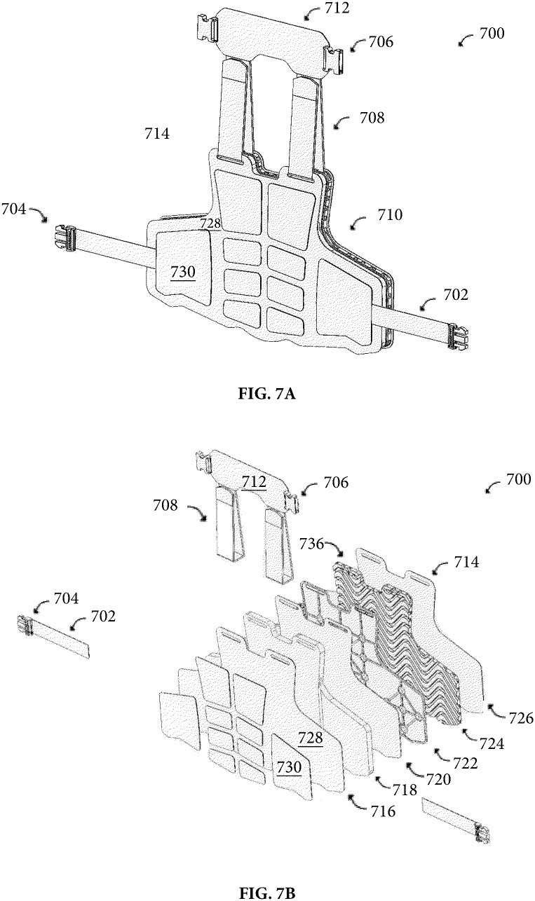

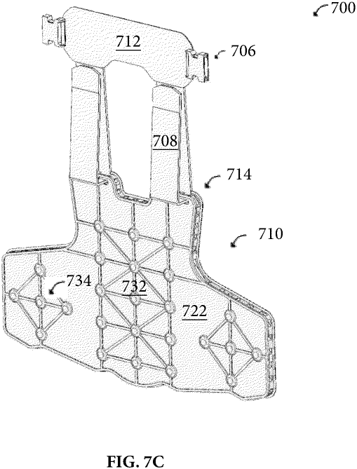

FIG. 7A illustrates a chest unit. As illustrated, A chest unit 700 may generally comprise a body 710 and a means of fastening body 710 to an object or person, such as with a belt strap 702 and clips/clip receivers 704 and 706. For example, belt strap 702 may be wrapped around an abdominal region 116 (referring to FIG. 1) to ensure that the body 710 remains tightly attached. While it is preferred that the belt strap is wrapped around an abdominal region, any suitable location could be used, such as by any means of attaching a life preserver, vest, or the like, to a person as is conventionally known. Clips 704 may be inserted into clip receivers 706. In use, chest unit 700 may be slung over a person or humanoid object such that the straps 708 rest on a trapezoid region 106 and a head 102 protrudes out from between straps 708, and arms 108 protrude out from regions between straps 708 and belt strap 702. A support 712 may maintain tension between belt straps 702 and body 710. Belt straps 702 may be adjusted to loosen or tighten the chest unit 700. Likewise, straps 708 may also be adjusted to ensure proper fit. Chest unit 700 may additionally comprise a surface 728 and/or surface padding 730. The surface padding 730 may be adhered to surface 728 by any suitable means, such as by an adhesive glue, and may comprise any suitable material for providing a cushion (e.g., fabric, soft foam, rigid foam, polymeric materials, rubber, plastic, hard plastic, etc.). As illustrated, straps 708 may be fed through holes 714. It is contemplated that chest unit 700 may be affixed to a punching bag, a rigid frame, a post, a fence, a mannequin, or any suitable object.

FIG. 7B is a layered view of a chest unit. As illustrated, body 710 of chest unit 700 may include one or more layers, such as layers 716, 718, 720, 722, 724, and 726 as shown. While the illustrated order of layers is the preferred example, it is contemplated that any rearrangement of the illustrated layers, or inserting/omitting of layers may be applied, provided that such adaptation does not interfere with performance. Layers 716-726 may comprise flexible, rigid, or semi-rigid layers. For example, layers 722 and 720 may comprises a rigid or semi-rigid layers, and layer 724 may comprise a padding, such as a D30 non-Newtonian foam. Any of layers 716, 718, and 726 may comprise padding or fabric, such as an expanded or foam rubber (EVA) padding or fabric. Layer 716 may comprise a flexible layer and may expose surface 728 to an external environment. Layer 718 may comprise, in preferred examples, one or more rigid or semi-rigid plates. The one or more rigid or semi-rigid plates may perform the function of redistributing an impact or an applied force across a greater area than a contact surface so as, for example, to redistribute the impact to the force sensing array. In examples where layer 718 comprises two rigid or semi-rigid plates, one or more standoffs (not shown) may be disposed between the two rigid or semi-rigid plates to redirect the impact as previously mentioned. It is further contemplated that high resistance springs could be used as an alternative to the standoffs. Layer 720 may comprise an additional protective layer disposed between layer 718 and layer 722.

Turning now to FIG. 7C, one or more system components may be embedded in a chest unit. System components may comprise a force sensing array 732. The force sensing array 732 may be disposed on a surface of layer 722. Force sensing array 732 may comprise a plurality of force sensing resistors 734. For example, and with reference to FIG. 7C, a total number of force sensing resistors 734 disposed on a layer 722 of chest unit 700 may comprise an amount greater than 1, 2, 5, 10, 15, 20, or 25 of total force sensing resistors 734. It is contemplated that an even greater number of force sensing resistors 734 than what is shown in FIG. 7C may be included, such as greater than 30, greater than 40, greater than 50, or greater than 100. The force sensing resistors may be in any suitable arrangement to provide accurate force readings to transmit to a processor. For example, in certain examples, a portion of the total number of force sensing resistors 732 disposed on a layer 722 may be characterized in that each force sensing resistor 732 of the portion is separated by a distance of at least ½ inch, 1 inch, 1 ½ inch, or 2 inches from a closest neighboring force sensing resistor 732. A portion may refer, in certain instances, to a percentage of the total number of force sensing resistors 732 disposed on a layer 722, included in a chest unit 700, or more generically, on any wearable garment. The percentage may be within a range of between 1% and 20%, between 20% and 40%, between 40% and 60%, between 60% and 80%, between 80% and 100%, between 20% and 60%, between 30% and 80%, between 40% and 90%, greater than 20%, greater than 5%, greater than 50%, or greater than 70%.

Moreover, chest unit 700 may comprise a device. The device (not shown) may comprise a transmitter unit 910 (referring to FIG. 9) or may otherwise comprise a device as disclosed in detail throughout this disclosure. The device may be disposed in or on any suitable location of chest unit 700, for example, such as in a device pocket (not shown) disposed on an outer surface of layer 726. In certain examples, certain regions such as a lower left, lower mid, lower right, central right, central mid, central left, upper left, upper mid, or upper right region may be ideal for placement of the device pocket to protect the device from impact. Alternatively, the device may be disposed in between one or more layers of chest unit 100 to protect it from impact. The force sensing resistors 734 may be electronically coupled, whether individually, in series, in parallel, or in series-parallel, to the device.

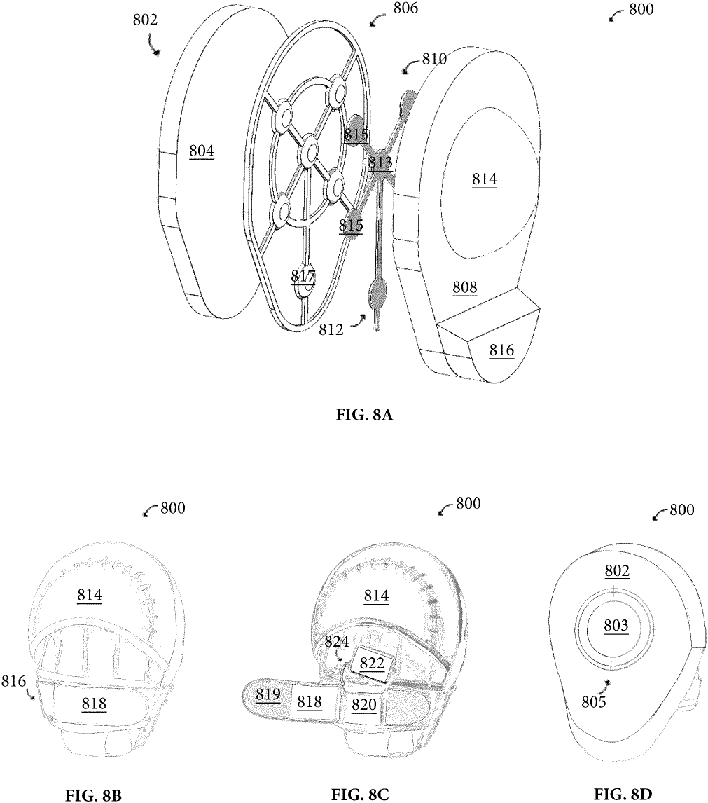

With continued reference to FIG. 7C, each force sensing resistor 734 and 815 (referring to FIG. 8A) has a diameter between about ½ inch and 2 inches in diameter, or preferably, about 1 inch. Sizes of force sensing resistors 734 and 815 may be selected to ensure accurate measurements, and any suitable size may be used. Each force sensing resistor may be capable of measuring as much as 220 N of force. Alternatively, each force sensing resistor may be characterized as being able to measure more than 50 N, more than 100 N, more than 150 N, more than 180 N, more than 200 N, or more than 210 N. Generally, the force sensing resistors 734 are arranged six at a time, or in other words, with six sensing resistors 734 per force sensing array 732, thereby amounting to a total of about 1320 N of force readable by a force sensing array 734 having six force sensing resistors 732. However, different numbers of force sensing resistors and/or different configurations/arrangements of force sensing arrays may be used. For example, a single force sensing array may comprise 1, 2, 3, 4, 5, 6, 7, 8, 9, 10, 11, 12, or more than 12 force sensing resistors. Alternatively, a single force sensing array may comprise more than 1, more than 2, more than 3, more than 4, more than 5, more than 6, more than 7, or more than 8 force sensing resistors. In some examples involving two or more single force sensing arrays, a combination of configurations may be employed, such as the configuration shown in FIG. 7C. For example, a first force sensing array having a number of force sensing resistors may be included in a system, and a second force sensing array having a different number of force sensing resistors may also be included in the system. Alternatively, the system could comprise both force sensing arrays having the same number of force sensing resistors.

With continued reference to FIG. 7C, layer 724 may comprise padding, such as padding having one or more ridges 736. The ridges may, among other things, dissipate at least a portion of an impact of a blow or strike applied to surface 728 such that a person or object wearing the chest unit 700 experiences a reduced amount of impact.

As illustrated, chest unit 700 may comprise a belt strap 702 having one or more clips 704 and/or clip receivers 706, one or more straps 708, a body 710, a support 712, holes 714, and one or more layers, such as layers 716, 718, 720, 722, 724, and 726 (as shown in FIG. 7B). Additionally, chest unit 700 may, in certain examples, comprise surface padding 730, as well as force sensing arrays 732, force sensing resistors 734, and ridges 736.

With continued reference to FIG. 7C, the chest unit 700 may comprise motion tracking sensors, location tracking sensors, force sensors and/or other system hardware components. Such hardware components may be implemented as previously described with gyroscopes, accelerometers, inertial measurement units, transmitters, receivers, FSRs, and the like. Chest unit 700 may comprise also comprise an IMU, a telemetry device, a chargeable power source, and one or more input ports. Sensors and/or system components may be electronically coupled or be in direct or indirect electronic communication with other sensors and/or system components, or may be wirelessly coupled to a processor via, for example, one or more telemetry devices and receivers.

FIG. 8A is a glove 800. Glove 800 may comprise a single glove 800 or a pair of gloves 800 which may be worn, for example, on one or more hands 112 (referring to FIG. 1). As illustrated, the glove 800 may comprise a surface 802, a layer 804, a layer 806 and force sensing array 810 comprising one or more force sensing resistors 815, and layer 808. A pocket 814 and piece 816 may be disposed on a surface of layer 808 or otherwise attached to layer 808. Layers 806 and 808 may comprise any suitable material, such as high- or low-density foams, leather, padding, or the like. As shown, the force sensing array 810 may be disposed between layers 804 and 808. In examples, force sensing array 810 is preferably adhered to layer 808, however, may be adhered to any surface within glove 800. Layer 806 may provide force sensing array 810 with structure and prevent sagging of the force sensing array 810 between layers 806 and 808. More importantly, layer 806 may protect force sensing resistors 815 from shear load, such as a shear load applied by an impact blow applied to surface 802. Preferably, layer 806 is a semi-rigid thermoplastic polyurethane layer. Layer 806 may comprise one or more protectors 817 disposed on a body of layer 806.

FIG. 8B illustrates a back side of glove 800 in a secured position with a fastener 819 (referring to FIG. 8C). Glove 800 may be secured to a hand 112 (referring to FIG. 1) by any suitable means, such as with an adjustable strap 818. As illustrated, an adjustable strap 818 may overlay a portion of glove 800 and/or piece 816, and may be configured to tighten or loosen, thereby affording easy access to an interior and/or inner surface (not shown) of glove 800 to hand 112 and/or wrist 110. Any suitable securing mechanism may be used, such as a drawstring, buckle, or any other securing mechanism known in the art. One or more glove components (not shown) may be disposed within an inner region of pocket 814 to be held, such as by a trainer, during use such that, for example, a position of glove 800 may be held steady during an impact. In some examples, pocket 814 may itself comprise a glove.

FIG. 8C illustrates a back side of glove 800 with device 822 embedded therein. As illustrated, device 822 may be disposed within pocket 820. While FIG. 8C only shows one specific location wherein device 822 and/or pocket 820 may be disposed, it should be understood that device 822 and/or pocket 820 may be disposed in or on any suitable location in or on glove 800. Cable 824 may be attached to device 822 and may, in some examples, electronically couple device 822 to force sensing array 810. In some examples, cable 824 may also be configured to electronically/energetically couple device 822 to a power source or may be otherwise operable to charge device 822.

Device 822 may comprise, in some examples, a transmitter unit 910 (referring to FIG. 9). In addition, or alternatively, device 822 may comprise any component selected from plastic casing, a microchip, an IMU, one or more gyroscopes, one or more accelerometers, a telemetry device, a transmitter, a receiver, GPS positioning systems, Wi-Fi positioning systems, radio frequency identification devices (RFID), combinations thereof, and/or any suitable electronic equipment for sensing an impact and transmitting a raw measurement and/or data to a processor.

FIG. 8D illustrates a front side of glove 822. As illustrated, surface 802 of glove 800 may comprise one or more target markings 805 disposed thereon. Target markings 805 may comprise, in some examples, one or more bull’s eye 803. In certain examples, target markings 805 and/or bull’s eye 803 may be aligned with force sensing array 810 such that an impact of a strike may be maximally conveyed to a plurality of force sensing resistors 815 (referring to FIG. 8A) if the strike is, for example, accurately directed at the target markings 805 and/or bull’s eye 803. For example, one or more target markings 805 may be overlaid on a center of force sensing array 819 (referring to FIG. 8A). Surface 802 may be configured to absorb an impact, such as a strike impact from a fist, foot, palm, elbow, knee, forehead, and the like.

In use, a “striker,” may direct a single or multiple striking blows at surface 802 of glove 800. A “trainer” may wear the glove 800 by putting one or more hands 112 (referring to FIG. 1) in pocket 814, and optionally, through piece 816 to provide resistance and dynamic movement to simulate a fighting scenario. Piece 816 may comprise, in certain examples, a strap, such as an adjustable strap 818 (referring to FIGS. 8B and 8C), and/or a fastener or fastening means to secure wrist 110 (referring to FIG. 1) to layer 808 or to piece 816. Pocket 814 may, in certain examples, include a piece and/or fabric (not shown) disposed therein such that a clenched fist of hand 112 may be securely disposed around the piece and/or fabric within glove 800 to hold the glove 800 steady during use. Striking blows that land on the surface 802 may trigger sensing by one or more of the sensors embedded within glove 800. The sensors, in turn, may relay raw measurement data to a device 822 (referring to FIG. 8C) which may further relay the data to a processor via, for example, a wireless signal 924 (referring to FIG. 9), as will be described in more detail.

It should be noted that, in certain examples, the striker may wear a wearable garment, such as wrist unit 200 (referring to FIGS. 2A-2E), training sleeve 400 (referring to FIG. 4), or ankle unit 300 (referring to FIG. 3A) when striking the glove 800. Alternatively, a striker may wear any wearable garment having its own device 822 embedded therein, such that a striking speed is measured, stored, and/or transmitted. In these examples, such a garment could possess a transmitter unit or one or more components thereof but lack a force sensing array and/or force sensing resistor. In this example, striking speed may be determined by detecting with an IMU disposed within the wearable garment a first “event,” such as an acceleration, change in inertia, or time of movement, and a processor may determine, based on an amount of time elapsed between the first event and a second event, a striking speed. A second even may comprise a time of impact. Alternatively, one or more of the wearable garments may be equipped with GPS, WiFi positioning systems, radio frequency identification devices (RFID), or other embedded motion detection hardware suitable for ascertaining movement, change in position, and/or striker speed.

Glove 800 may also be used to determine striker accuracy. For example, striker accuracy may be determined from a total amount of force measured by a force sensing array 810, or alternatively, by parsing raw measurements into FSR-specific data, or by individually transmitting raw measurements for each FSR 812 to a processor and comparing or performing data analysis on the raw measurement data set. For example, a raw measurement or raw measurement-derived value corresponding to central FSR 813 may be compared to a single raw measurement or raw measurement-derived value from a neighboring FSR 815, or to an average raw measurement or raw measurement-derived value corresponding to two or more FSRs (FSRs 815, or a combination of FSRs 815 with FSR), or to an average raw measurement or raw measurement-derived value corresponding to all FSRs 812, 813, and 815 in a single force sensing array 810 . In some examples, a weighted average may be used such that one or more FSRs 813 of a force sensing array 810 is weighted higher than another FSR or combination of FSRs. Any suitable values may be assigned to a specific FSRs to accord greater weight to it, such as by a factor of at least 10% more, at least 20% more, at least 30% more, at least 40% more, at least 50% more, at least 60% more, at least 80% more, or at least 90% more as compared to another FSR or combination of FSRs in the same force sensing array.

Glove 800 may also be used to determine striker power. In examples, striker power may be determined by correlating a cumulative value corresponding to a sum of raw measurements or raw measurement-derived values from a group (e.g., all) of FSRs in a force sensing array to a performance metric. In alternative examples, if a strike lands on a region of a surface 802 where a density of underlying FSRs is sparse, a raw measurement or raw measurement-derived value from a single impacted FSR may be extrapolated to account for the sparsity. The region may be defined as a localized region, such as a region comprising a typical surface area of a fisted contact surface, or else by a circular region having a radius of about 1 inch, about 1.5 inches, about 2 inches, about 2.5 inches, about 3 inches, about 3.5 inches, about 4 inches, about 4.5 inches, about 5 inches, about 5.5 inches, or about 6 inches. Even more simply, a maximum raw measurement or raw measurement-derived value of a plurality of raw measurements or raw measurement-derived values may be used and/or correlated to produce the performance metric.

While only a few examples are provided, it should be understood that the processes and system configurations listed above may be applied to other wearable garments and/or combinations of other wearable garments, such as to any of the wearable garments previously described, without departing from the spirit of disclosure.

FIG. 9 illustrates an exemplary schematic representing processing system 900 in accordance with certain examples. As illustrated, the system 900 may generally comprise a force sensing array 902, a transmitter unit 910, and a processor 922. As illustrated, the transmitting unit 910 may comprise a power source 912, one or more IMUs 918, one or more microchips 914, one or more ports 908, and a telemetry device 916. The processor 922 may comprise a transmitter 920 operable to receive a signal 924 broadcasted by the telemetry device 916. The processor 922 may be a portable computer, portable phone, or comparable device. In examples, the processor 922 may display data, such as an output of the processor 922. Additionally, the display device may be configured and operable to render a graphical user interface (GUI). The data may comprise, among other things, one or more performance metrics.

Optionally, performance-specific feedback may be generated based on the data, the raw measurements from any of one or more garments, and/or raw-measurement derived values.

A performance metric may include, without limitation, striking speed, striking power, striking accuracy, and/or any combination thereof. The performance metric may be derived, at least in part, from raw measurements gathered by one or more IMUs, one or more FSRs, one or more gyroscopes, one or more accelerometers, or from any combination of sensors and/or hardware provided in the present disclosure. For example, the raw measurements may be relayed via signal 924 from a telemetry device 916 electronically coupled to a microchip 914 to receiver 920 of processor 922. Telemetry device 916 may send and receive signal 924 through a bus (not shown), wired communications, or wirelessly via electromagnetic waves. The processor 922 may be equipped with computation hardware and/or computation algorithms, such as with any computational hardware and/or computational algorithms that are known in the art. The processor 922 may convert the raw measurements to a user-friendly output, such as a performance metric. (It should be understood that, while FIG. 9 shows a receiver 920 receiving a signal 924 comprising raw measurements from IMU 918 and a force sensing array 902 comprising a plurality of FSRs 904to a single system (e.g., a single wearable garment comprising the FSRs and IMU), that receiver 920 may receive multiple signals 924 from a plurality of telemetry devices 916, the plurality of telemetry devices disposed on multiple systems). For example, measurement data received by receiver 920 may originate from a plurality of sources, for example, from both a first wearable unit and a second wearable unit, or more specifically, from both a glove 800 (referring to FIG. 8) and, say, an adjustable wristband (e.g., an adjust wristband comprising an IMU).

In examples, IMU 918 may comprise at least one or more accelerometers, gyroscopes, or magnetometers. IMU 918 may allow for the measurement of mass-specific force, g-force, angular rate, and acceleration in all three axes to calculate orientation angles. In some examples, IMU 918 has six degrees of freedom.

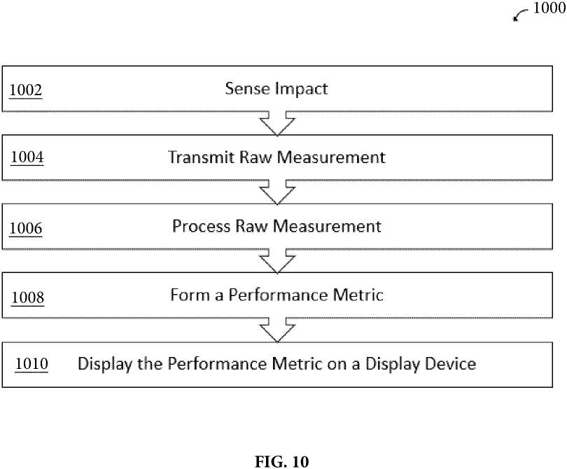

FIG. 10 is a work flow 1000 for an example system. As illustrated, a system (not shown) may be configured to sense an impact in block 1002. Raw measurements may be formed during block 1002 or between block 1002 and 1004. The system may be configured to transmit the one or more raw measurements in block 1004. The system may be configured to process the one or more raw measurements in block 1006, for example, with processor 922 (referring to FIG. 9). The system may be configured to form a performance metric in block 1008, such as at least one of strike speed, strike accuracy, strike power, and/or any combination thereof. One or more performance metrics may be displayed on a display device in block 1010, such as on a computer screen, mobile application, GUI, wearable computer, and/or any combination thereof.

To facilitate a better understanding of the present invention, the following examples of certain aspects of some embodiments are given. In no way should the following examples be read to limit, or define, the entire scope of the disclosure.

### EXAMPLES

An example method may comprise sensing an impact on a surface of one or more wearable garments (referring to FIGS. 2-9) to form one or more first raw measurements. The method may further comprise transmitting the first raw measurements to a receiver, wherein the receiver is electronically coupled to a processor. The method may further comprise processing at least the first raw measurement with the process to generate data. The method may further comprise forming one or more performance metrics with the data. The performance data may comprise, for example, strike speed, strike power, strike accuracy, or any combination thereof. The method may further comprise rendering the performance metric on a graphical user interface. The method may, in certain examples, further comprise tracking a movement of the one or more wearable garments to form at least a second raw measurement with the at least one or more sensors. The second raw measurement may correspond to the one or more wearable garments, or to an additional wearable garment. The method may further comprise, in certain examples, determining a time of impact based on the first raw measurement, the second raw measurement, or both. The method may further comprise, in some examples, determining a time of movement based on the second raw measurement. The performance metric may be calculated based on the time of movement and the time of impact by, for example, by taking of the difference of the two to determine an elapsed time. The method may comprise performing a weighted average, and/or performing a sum.

Although specific examples have been described above, these examples are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but examples may provide some, all, or none of such advantages, or may provide other advantages.

What is claimed is:

1. A system comprising:
one or more wearable garments, wherein each wearable garment of the one or more wearable garments comprises:
one or more layers;
an outer surface;
a force sensing array comprising a plurality of force sensing resistors;
an inertial measurement unit; and
a transmitter unit, and
a processor, wherein the processor comprises one or more receivers.

2. The system of claim 1, wherein the transmitter unit comprises two or more input ports, wherein at least one input port of the two or more input ports is configured to receive raw measurements from the inertial measurement unit.

3. The system of claim 2, wherein at least one input port of the two or more input ports is configured to receive raw measurements from the force sensing array.

4. The system of claim 3, wherein the transmitter unit comprises a telemetry device configured to record and transmit one or more raw measurements from the force sensing array or inertial measurement unit.

5. The system of claim 4, wherein the one or more receivers are configured to receive the one or more raw measurements from the telemetry device.

6. The system of claim 5, wherein the processor is configured to determine one or more performance metrics based on at least the one or more raw measurements.

7. The system of claim 6, wherein the performance metrics comprises strike speed, strike force, strike accuracy, or any combination thereof.

8. The system of claim 6, further comprising a display device, wherein the display device is configured to display the one or more performance metrics.

9. The system of claim 8, wherein the display device comprises a graphical user interface.

10. The system of claim 1, wherein the one or more wearable garments are configured as a head unit, a chest unit, an ankle unit, a leg unit, an arm unit, a glove, or any combination thereof.

11. The system of claim 1, wherein at least one of the one or more layers comprises a rigid or semi-rigid plate operable to redistribute a force applied to the surface to the plurality of force sensing resistors.

12. The system of claim 11, wherein at least one of the one or more layers comprises padding.

13. The system of claim 12, wherein the force sensing array is disposed between the padding layer and one of the rigid or semi-rigid plates.

14. The system of claim 1, wherein the wearable garment further comprises an adjustable strap attached to at least one of the one or more layers.

15. The system of claim 1, wherein for each of a portion of the force sensing resistors, a distance of at least ½ inch separates the force sensing resistor to a closest neighboring force sensing resistor, wherein the portion comprises at least 60% of a total number of the force sensing resistors.

16. A system comprising:
one or more wearable garments, wherein each wearable garment of the one or more wearable garments comprises:
one or more layers;
an outer surface;
a force sensing array comprising a plurality of force sensing resistors;
an inertial measurement unit; and
a transmitter unit; and
an adjustable wristband, wherein the adjustable wristband comprises:
an adjustable strap;
an inertial measurement unit; and
a telemetry device, and
a processor, wherein the processor comprises one or more receivers.

17. The system of claim 16, wherein the transmitter unit and the telemetry device are configured to transmit one or more raw measurements to the one or more receivers.

18. The system of claim 17, wherein the processor is configured to determine one or more performance metrics based on at least the one or more raw measurements.

19. The system of claim 18, wherein the one or more performance metrics comprise strike speed, strike force, strike accuracy, or any combination thereof.

20. The system of claim 18, further comprising a display device, wherein the display device is configured to display the one or more performance metrics.
